(19) United States
(12) Patent Application Publication
(10) Pub. No.: US 2025/0048390 A1
(43) Pub. Date: Feb. 6, 2025

(54) METHOD FOR INDICATING TA, AND DEVICE

(71) Applicant: GUANGDONG OPPO MOBILE TELECOMMUNICATIONS CORP., LTD., Dongguan (CN)

(72) Inventors: Jianfei CAO, Dongguan (CN); Zhe LIU, Dongguan (CN)

(21) Appl. No.: 18/898,216

(22) Filed: Sep. 26, 2024

Related U.S. Application Data
(63) Continuation of application No. PCT/CN2022/086869, filed on Apr. 14, 2022.

(51) Int. Cl. H04W 72/232; H04L 5/00

(52) U.S. Cl. CPC H04W 72/232; H04L 5/0053

(57) ABSTRACT

Provided is a method for indicating a TA. The method is applicable to a terminal device, a serving cell of the terminal device comprising m transmission and reception points (TRPs), m being a positive integer greater than or equal to 1, and the method includes: receiving downlink signaling, wherein the downlink signaling indicates at least one TA, each of the at least one TA corresponding to one of the m TRPs; and updating the at least one TA based on the downlink signaling.

### CROSS-REFERENCE TO RELATED APPLICATION

This application is a continuation application of international application No. PCT/CN2022/086869, filed on Apr. 14, 2022, the disclosure of which is incorporated herein by reference in its entirety.

### TECHNICAL FIELD

The present disclosure relates to the field of communications technologies, and in particular, relats to a method for indicating a timing advance (TA), and a device thereof.

### BACKGROUND

A TA is configured for uplink transmission of a terminal device. The TA means that a system frame in which the terminal device transmits uplink data is a specific time earlier than a corresponding downlink frame, such that of from different terminal devices coming from a same subframe but occuply different frequency domain resources arrive at a network device at basically aligned time points.

### SUMMARY

Embodiments of the present disclosure provide a method for indicating a TA, and a device thereof. The technical solutions are as follows.

According to some embodiments of the present disclosure, a method for indicating a TA is provided. The method is applicable to a terminal device. A serving cell of the terminal device includes m TRPs, wherein m is a positive integer greater than or equal to 1. The method includes:
receiving downlink signaling, wherein the downlink signaling indicates at least one TA, each of the at least one TA corresponding to one of the m TRPs; and
updating the at least one TA based on the downlink signaling.

According to some embodiments of the present disclosure, a method for indicating a TA is provided. The method is applicable to a network device. The network device includes m TRPs, wherein m is a positive integer greater than or equal to 1. The method includes:
transmitting downlink signaling, wherein the downlink signaling indicates at least one TA, each of the at least one TA corresponding to one of the m TRPs.

The downlink signaling is configured for a terminal device to update the at least one TA.

According to some embodiments of the present disclosure, a terminal device is provided. A serving cell of the terminal device includes m TRPs, wherein m is a positive integer greater than or equal to 1. The terminal device includes a transceiver and a processor.

The transceiver is configured to receive downlink signaling. The downlink signaling indicates at least one TA. Each of the at least one TA corresponds to one of m TRPs.

The processor is configured to update the at least one TA based on the downlink signaling.

According to some embodiments of the present disclosure, a network device is provided. The network device includes m TRPs, wherein m is a positive integer greater than or equal to 1. The network device includes a transceiver.

The transceiver is configured to transmit downlink signaling. The downlink signaling indicates at least one TA. Each of the at least one TA corresponds to one of m TRPs.

The downlink signaling is configured for a terminal device to update the at least one TA.

### BRIEF DESCRIPTION OF DRAWINGS

For clearer descriptions of the technical solutions according to the embodiments of the present disclosure, the following briefly describes accompanying drawings required for describing the embodiments. Apparently, the accompanying drawings in the following description illustrate merely some embodiments of the present disclosure, and those of ordinary skill in the art can still derive other accompanying drawings from these accompanying drawings without creative efforts.

FIG. 1 is a schematic diagram of a medium access control (MAC) control element (CE) according to some embodiments of the present disclosure;

FIG. 2 is a schematic diagram of a MAC CE according to some embodiments of the present disclosure;

FIG. 3 is a schematic diagram of a communication system according to some embodiments of the present disclosure;

FIG. 4 is a flowchart of a method for indicating a TA according to some embodiments of the present disclosure;

FIG. 5 is a schematic diagram of an uplink and downlink transmission scenario of a multi-downlink control information (DCI) mTRP (mDCI-mTRP) according to some embodiments of the present disclosure;

FIG. 6 is a schematic diagram of an uplink and downlink transmission scenario of a single-DCI mTRP (sDCI-mTRP) according to some embodiments of the present disclosure;

FIG. 7 is a schematic diagram of a MAC CE according to some embodiments of the present disclosure;

FIG. 8 is a schematic diagram of a MAC CE according to some embodiments of the present disclosure;

FIG. 9 is a schematic diagram of updating a TA of an mDCI-mTRP according to some embodiments of the present disclosure;

FIG. 10 is a schematic diagram of a MAC CE according to some embodiments of the present disclosure;

FIG. 11 is a schematic diagram of a MAC CE according to some embodiments of the present disclosure;

FIG. 12 is a schematic diagram of a MAC CE according to some embodiments of the present disclosure;

FIG. 13 is a schematic diagram of a MAC CE according to some embodiments of the present disclosure;

FIG. 14 is a flowchart of a method for indicating a TA according to some embodiments of the present disclosure;

FIG. 15 is a schematic diagram of a MAC CE according to some embodiments of the present disclosure;

FIG. 16 is a schematic diagram of a MAC CE according to some embodiments of the present disclosure;

FIG. 17 is a flowchart of a method for indicating a TA according to some embodiments of the present disclosure;

FIG. 18 is a structural block diagram of an apparatus for indicating a TA according to some embodiments of the present disclosure;

FIG. 19 is a structural block diagram of an apparatus for indicating a TA according to some embodiments of the present disclosure; and

FIG. 20 is a schematic structural diagram of a communication device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

First, technical knowledge involved in the embodiments of the present disclosure is briefly described hereinafter.

### TA

In an existing new radio (NR) standard (including 3GPP Rel.17), a terminal device may be configured with up to four TAGs in a cell group (CG). Generally, one CG may include a plurality of serving cells, wherein each of the plurality of serving cells is assigned a TAG-Id. A radio resource control (RRC) configuration of a TAG may be as follows.

```
-- ASN1START
-- TAG-TAG-CONFIG-START
TAG-Config ::= SEQUENCE {
    tag-ToReleaseList SEQUENCE (SIZE (1..maxNrofTAGs)) OF TAG-Id OPTIONAL,
-- Need N
  tag-ToAddModList SEQUENCE (SIZE (1..maxNrofTAGs)) OF TAG OPTIONAL --
Need N
    }
TAG ::= SEQUENCE {
    tag-Id TAG-Id,
    timeAlignmentTimer TimeAlignmentTimer,
      ...
    }
TAG-Id ::= INTEGER (0..maxNrofTAGs−1)
TimeAlignmentTimer ::= ENUMERATED {ms500, ms750, ms1280, ms1920, ms2560, ms5120,
ms10240, infinity}
-- TAG-TAG-CONFIG-STOP
-- ASN1STOP
```

A TA of the terminal device is calculated according to the formula: (N_{TA}+N_{TA,offset})*T_{C}. The TA of the terminal device means that transmission is performed in advance with a first symbol of a downlink channel received by the terminal device or a slot of the channel as a downlink reference.

Parameters in the TA calculation formula are described hereinafter. In one CG, each serving cell may be preconfigured with a TA offset n-TimingAdvanceOffset, i.e., N_{TA,offset} in the formula. A TA adjustment amount N_{TA} is based on the preconfigured TA offset. T_{C} is a minimum time unit in an NR system. T_{C}=1/(4096*480 kHz).

Based on the above formula for calculating the TA, two TA update manners are available.

The first TA update manner is difference-based TA update. N_{TA} may be differentially updated based on a MAC CE from a network device. That is, a current TA is acquired by adjusting a previous TA forward or backward in time. A calculation formula is as follows:

$${N}_{( {TA}_{new} )} = {N}_{( {TA}_{old} )} + ( {T}_{A} - 31 ) * 16 * 64 * / {2}^{μ}$$

In the calculation formula, u represents a value corresponding to a subcarrier spacing, N_{TA_old} represents an N_{TA} value before indication, N_{TA_new} represents a N_{TA} value after indication, and T_{A} represents a value indicated in the MAC CE. T_{A}=0, 1, 2, . . . , 63.

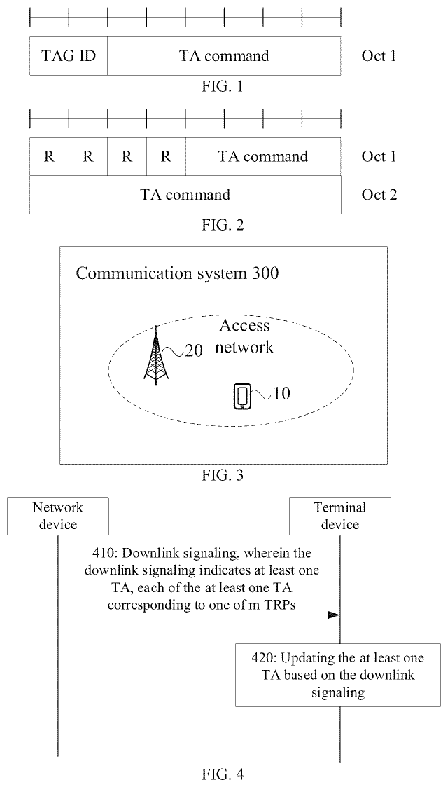

A differential adjustment format of a TA of a MAC CE is illustrated in FIG. 1. That is, the previous TA is adjusted by T_{A} minimum time units, wherein a granularity of the TA adjustment is TAG.

In FIG. 1, a Tag ID field is defined to identify a TAG. For example, a Tag ID of a TAG including a special cell (SpCell) is 0, wherein the Tag ID field is 2 bits in length. A TA command field indicates a TA index value (0, 1, 2, . . . , 63), wherein the TA index value is defined to control a timing adjustment amount that a MAC entity must apply (TS 38.213[6]), and the TA command field is 6 bits in length.

The second TA update manner is absolute value-based TA update. An absolute value of a TA is adjusted. That is, a MAC CE from a network device directly provides an absolute value T_{A} without considering a previous TA value. T_{A}=0, 1, 2, . . . , 3846. A TA adjustment range is N_{TA}=T_{A}*16*64*2^{μ}. In addition, the TA command is applicable to a primary TAG (PTAG) corresponding to the MAC entity. The PTAG is defined as a TAG including a SpCell. Because the MAC CE is applicable only to the PTAG, the MAC CE does not need to include a TAG-Id.

An absolute value adjustment format of a TA of a MAC CE is illustrated in FIG. 2. In FIG. 2, a TA command field indicates a TA index value, wherein the TA index value is defined to control a timing adjustment amount that a MAC entity shall apply (TS 38.213[6]), and the TA command field is 12 bits in length. An R field is a reserved bit and is set to 0.

Uplink mTRP Operation

In 3GPP Rel.17, mTRP-based physical uplink control channel (PUCCH)/physical uplink shared channel (PUSCH) repetitions are supported to enhance uplink coverage and transmission reliability. A terminal device needs to transmit PUCCHs/PUSCHs carrying same content to different TRPs. With respect to PUSCH repetitions, only sDCI-based PUSCH repetitions are supported in an existing standard. The PUSCHs are sequentially transmitted to different TRPs using the same TA. With respect to mDCI-based PUSCH repetitions, because there may not be enough ideal backhaul as a connection between a plurality of TRPs, independently scheduling the terminal device by the plurality of TRPs may cause different PUSCHs/PUCCHs to overlap in time. This situation is not conducive to implementation of the terminal device.

With respect to sDCI-based PUSCH repetitions, a sounding reference signal (SRS) resource set indicator field is used in uplink scheduling DCI. This field may indicate one or two SRS resource sets. This field points to transmission to one or two TRPs and can dynamically adjust uplink transmission of a single TRP (sTRP) or the mTRP. In TS 38.212, the field is described as follows.

The SRS resource set indicator field is 0 or 2 bits in length. The SRS resource set indicator field is 2 bits in length if txConfig=non CodeBook and two SRS resource sets are configured by SRS-ResourceSetToAddModList and associated with usage of the value “non CodeBook”; or txConfig=codebook and two SRS resource sets are configured by SRS-ResourceSetToAddModList and associated with usage of the value “codebook”. The field is 0 bits in length in other cases.

TABLE 1

| Bit field | |
|---|---|
| mapped to | |
| index | SRS resource set indicator |
| 0 | SRS resource indicator field and precoding information and number of layers |
| | field are associated with a first SRS resource set; second SRS resource |
| | indicator field and second precoding information field are reserved. |
| 1 | SRS resource indicator field and precoding information and number of layers |
| | field are associated with a second SRS resource set; second SRS resource |
| | indicator field and second precoding information field are reserved. |
| 2 | SRS resource indicator field and precoding information and number of layers |
| | field are associated with a first SRS resource set; second SRS resource |
| | indicator field and second precoding information field are associated with a |
| | second SRS resource set. |
| 3 | SRS resource indicator field and precoding information and number of layers |
| | field are associated with a first SRS resource set; second SRS resource |
| | indicator field and second precoding information field are associated with a |
| | second SRS resource set. |

As seen from Table 1, although words such as TRP are not directly used for an uplink in the standard, the first SRS resource set and the second SRS resource set can be used to represent a first TRP and a second TRP respectively.

In addition, with respect to a TA of an uplink channel and signal, PUSCHs/PUCCHs/SRSs (regardless of whether the PUSCHs/PUCCHs/SRSs are transmitted to one TRP or two TRPs) are transmitted using the same TA value, such that it is not very difficult to implement radio frequency (RF) of the terminal device. However, one TA value causes a time difference of arrival at different TRPs, thereby resulting in impacts on uplink performance, such as coverage and interference.

As described above, an existing TA indication technology can only adjust a TA with the granularity being the TAG (including difference-based TA adjustment or absolute value-based TA adjustment). In addition, a minimum unit of the TAG is one serving cell. With respect to intra-cell mTRP transmission, a plurality of TRPs belong to one cell. With respect to inter-cell mTRP transmission, up to seven cells with different physical cell identifiers (PCIs) are present. Apparently, four TAGs are not enough. Consequently, there must be a plurality of TRPs using the same TA value within one TAG.

However, considering implementation in the physical world, the terminal device is often at different distances from different TRPs, and delay characteristics of a channel, such as a delay spread and an average delay, are significantly different. Therefore, it is necessary to introduce a TA adjustment solution for different TRPs.

That is, in the related art, a network device instructs, with a granularity being TA group (TAG), a terminal device to adjust a TA used by the terminal device. However, in a multi-transmission and reception point (mTRP) uplink transmission scenario, a plurality of TRPs may use the same TA. A method for indicating a TA in this scenario needs to be considered.

In view of the foregoing problem, in the embodiments of the present disclosure, a network device transmits downlink signaling to a terminal device. The downlink signaling indicates at least one TA. Each of the at least one TA corresponds to one TRP. Correspondingly, the terminal device updates the at least one TA. In this way, the terminal device can adjust TA values corresponding to different TRPs, such that each of the TRPs can receive uplink transmission from the terminal device at an appropriate time point.

The following further describes a method for indicating a TA provided in the embodiments of the present disclosure.

FIG. 3 is a schematic diagram of a communication system according to some embodiments of the present disclosure. The communication system 300 may include a terminal device 10 and an access network device 20.

For example, the terminal device 10 is a user equipment (UE), an access terminal, a subscriber unit, a subscriber station, a mobile station, a mobile platform, a remote station, a remote terminal, a mobile device, a wireless communication device, a user agent, or a user apparatus. In some embodiments, the terminal device 10 is a cellular phone, a cordless phone, a Session Initiation Protocol (SIP) phone, a wireless local loop (WLL) station, a personal digital assistant (PDA), a handheld device with a wireless communication function, a computing device or another processing device connected to a wireless modem, a vehicle-mounted device, a wearable device, a terminal in a 5^{th} generation (5G) mobile communication system or a future evolved public land mobile network (PLMN), or the like. The type of the terminal device 10 is not limited in the embodiments of the present disclosure. For convenience of description, the devices mentioned above are collectively referred to as the terminal.

The access network device 20 is a device deployed in an access network to provide a wireless communication function for the terminal device 10. The access network device 20 may include various forms of macro base stations, micro base stations, relay stations, access points, and the like. In systems employing different radio access technologies, a device with a function of the access network device may have different names, for example, gNodeB or gNB in a 5G NR system. As a communication technology evolves, the name “access network device” may change. For convenience of description, in the embodiments of the present disclosure, apparatuses providing the wireless communication function for the terminal device 10 are collectively referred to as the access network device. In some embodiments, a communication relationship is established between the terminal device 10 and a core network device over the access network device 20. For example, in a long-term evolution (LTE) system, the access network device 20 is an evolved universal terrestrial radio access network (EUTRAN) or one or more eNodeBs in the EUTRAN. In the 5G NR system, the access network device 20 is a radio access network (RAN) or one or more gNBs in the RAN. The network device in the embodiments of the present disclosure is the access network device 20.

In an example, one access network device 20 includes one or more TRPs, or one gNB may include one or more antenna panels.

The “5G NR system” in the embodiments of the present disclosure may also be referred to as a 5G system or an NR system, but a person skilled in the art can understand their meanings. The technical solutions described in the embodiments of the present disclosure may be applicable to the LTE system, the 5G NR system, or an evolved system subsequent to the 5G NR system, which is not limited in the present disclosure.

FIG. 4 is a flowchart of a method for indicating a TA according to some embodiments of the present disclosure. The method may be applied to a communication system. The method may include the following processes.

In 410, a network device transmits downlink signaling to a terminal device, wherein the downlink signaling indicates at least one TA, each of the at least one TA corresponds to one of m TRPs.

Correspondingly, the terminal device receives the downlink signaling. The downlink signaling indicates the at least one TA. Each of the at least one TA corresponds to one of the m TRPs.

In the embodiments of the present disclosure, a serving cell of the terminal device includes the m TRPs, wherein m is a positive integer greater than or equal to 1. That is, the terminal device supports an mTRP uplink transmission scenario. For example, the terminal device concurrently performs uplink communication with a plurality of TRPs.

For example, m is 2 and the terminal device supports a 2-TRP uplink transmission scenario. For example, m is X and the terminal device supports an X-TRP uplink transmission scenario, wherein X is a positive integer greater than 2.

In the embodiments of the present disclosure, the downlink signaling is signaling that indicates updating or adjusting a TA. The downlink signaling indicates updating or adjusting one or more TAs. Each of the one or more TAs corresponds to one TRP.

For example, the downlink signaling indicates updating or adjusting TA #a corresponding to TRP #a, wherein TRP #a is one of the m TRPs in the mTRP uplink transmission scenario.

For example, the downlink signaling indicates updating or adjusting m TAs corresponding to the m TRPs.

It should be understood that because each of the at least one TA corresponds to one TRP, the embodiments of the present disclosure may be considered as proposing a TRP-specific TA adjustment solution. TA values corresponding to different TRPs can be adjusted.

For example, the downlink signaling includes at least one of a MAC CE or DCI.

In some embodiments, prior to process 410, the method further includes the following process. The terminal device reports capability information of the terminal device to the network device, wherein the capability information includes at least one of: information indicating whether the terminal device supports TRP-specific TA adjustment, or a maximum quantity of TAs supported by the terminal device. Correspondingly, the network device receives the capability information reported by the terminal device, wherein the capability information includes at least one of: information indicating whether the terminal device supports TRP-specific TA adjustment, or the maximum quantity of TAs supported by the terminal device.

TRP-specific TA adjustment is to adjust the TA values corresponding to different TRPs.

That is, the terminal device needs to report, over the capability information of the terminal device, whether TRP-specific TA adjustment is supported.

In some embodiments, the terminal device can use a plurality of independent uplink antenna panels to transmit to different TRPs, such that the terminal device can support operations, such as configuration and update, on up to Y (for example, 2) TAs. Therefore, the terminal device reports, over the capability information, that the terminal device supports TRP-specific TA adjustment and up to Y TAs.

In some embodiments, the terminal device can use only one uplink RF link, such that the terminal device can support operations on only one TA, that is, not supporting configuration and application of a plurality of TAs. Therefore, the terminal device reports, over the capability information, that the terminal device does not support TRP-specific TA adjustment.

In 420, the terminal device updates the at least one TA based on the downlink signaling.

Upon receiving the downlink signaling, the terminal device updates the at least one TA corresponding to at least one TRP as instructed by the downlink signaling.

In some embodiments, the downlink signaling is defined to instruct the terminal device to perform the difference-based TA update or the absolute value-based TA update.

That is, the TA update in the embodiments of the present disclosure includes the difference-based TA update and the absolute value-based TA update. For details about the difference-based TA update and the absolute value-based TA update, reference may be made to the description above, which are not described herein any further.

In an example, because the TA is updated or adjusted with the granularity being the TAG, the downlink signaling in the embodiments of the present disclosure is defined to provide at least two TAs for one TAG and each of the at least two TAs corresponds to one TRP. Alternatively, different TRPs are allocated to different TAGs, the downlink signaling in the embodiments of the present disclosure is defined to provide one TA for one TAG, wherein the TA corresponds to one TRP.

In summary, in the method for indicating the TA according to these embodiments, the network device transmits the downlink signaling to the terminal device. The downlink signaling indicates the at least one TA. Each of the at least one TA corresponds to one TRP. Correspondingly, the terminal device updates the at least one TA. In this way, the terminal device is capable of adjusting the TA values corresponding to different TRPs, such that each TRP is capable of receiving uplink transmission from the terminal device at an appropriate time point.

In some embodiments, the downlink signaling indicates updating a plurality of TAs corresponding to a plurality of TRPs or updating one TA corresponding to one TRP.

The downlink signaling indicates the m TAs corresponding to the m TRPs.

That is, the downlink signaling may adopt an implementation 1.

The implementation 1: One piece of downlink signaling indicates TA values corresponding to a plurality of TRPs.

The implementation 1 may include an implementation 1.1 and an implementation 1.2.

The implementation 1.1: One MAC CE indicates the TA values corresponding to the plurality of TRPs.

The implementation 1.2: One piece of DCI indicates the TA values corresponding to the plurality of TRPs.

The downlink signaling indicates one TA, wherein the TA corresponds to one of the m TRPs.

That is, the downlink signaling may adopt an implementation 2.

The implementation 2: One piece of downlink signaling indicates a TA value corresponding to one TRP.

The implementation 2 may include an implementation 2.1.

The implementation 2.1: One MAC CE indicates a TA value corresponding to one TRP.

In some embodiments, mTRP uplink transmission includes sDCI-mTRP uplink transmission and mDCI-mTRP uplink transmission.

The sDCI-mTRP uplink transmission means that PUSCH transmission of a plurality of TRPs is scheduled over one piece of DCI.

The mDCI-mTRP uplink transmission means that a plurality of TRPs are present and each of the plurality of TRPs schedules its PUSCH transmission over its own DCI.

In the embodiments of the present disclosure, the sDCI-mTRP uplink transmission is a TA update solution associated with an SRS resource set. The TA is updated as instructed by the DCI, wherein the DCI is taken as the downlink signaling. The mDCI-mTRP uplink transmission is a TA update solution associated with a control resource set pool index (CORESETPoolIndex). The TA is updated as instructed by the MAC CE, wherein the MAC CE is taken as the downlink signaling.

That is, the implementation 1.2 is applicable to sDCI-mTRP uplink transmission, and is a TA update solution associated with the SRS resource set. The implementation 1.1 and the implementation 2.1 are applicable to mDCI-mTRP uplink transmission, and are TA update solutions associated with the CORESETPoolIndex.

It should be understood that during mDCI-mTRP uplink transmission, a demand for DCI is large and each TRP is independently scheduled in comparison with sDCI-mTRP uplink transmission. Therefore, a quantity of CORESETs occupied by the DCI is increased. In addition, the CORESETs are grouped based on their RRC parameter control resource set pool indexes. Each control resource set pool index corresponds to one TRP. In the case that the network device does not configure a control resource set pool index for a CORESET, a default value of the control resource set pool index is 0. That is, during mDCI-mTRP uplink transmission, a TRP may be identified by a control resource set pool index.

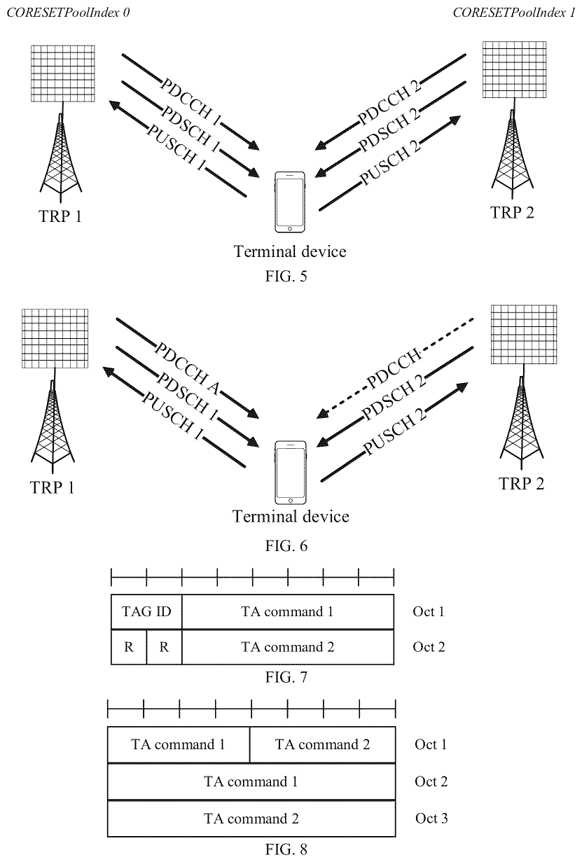

In some embodiments, FIG. 5 illustrates mDCI-mTRP uplink and downlink transmission. Each TRP may schedule its PDSCH transmission over its own DCI, or each TRP may schedule its PUSCH transmission over its own DCI. CORESETs with CORESETPoolIndex 0 are in a group corresponding to one TRP: TRP 1. CORESETs with CORESETPoolIndex 1 are in a group corresponding to another TRP: TRP 2.

It should be understood that during sDCI-mTRP uplink transmission, the network device does not configure a second (including a case in which the default value of CORESETPoolIndex is 0) CORESETPoolIndex value. Consequently, the terminal device cannot distinguish different TRPs based on this RRC parameter. For example, an sDCI-mTRP operation is illustrated in FIG. 6. The terminal device cannot distinguish different TRPs based on downlink scheduling physical downlink control channels (PDCCHs), and can only find an indicated TRP based on an indicated SRS resource set field. That is, during sDCI-mTRP uplink transmission, a TRP may be identified by an SRS resource set.

The following further describes a method for indicating a TA in different uplink transmission scenarios.

1. mDCI-mTRP uplink transmission scenario: a TA update solution associated with a control resource set pool index, in which the TA is updated as instructed by the MAC CE as the downlink signaling.

The implementation 1.1: One MAC CE indicates the TA values corresponding to the plurality of TRPs.

In this implementation, the downlink signaling is a first MAC CE. The first MAC CE is applicable to the mDCI-mTRP uplink transmission scenario. The first MAC CE includes m TA command fields. Each of the m TA command fields corresponds to one control resource set pool index. Each control resource set pool index corresponds to one TRP.

In this implementation, an enhanced MAC CE structure is designed. The MAC CE includes a plurality of TA command fields. Each of the plurality of TA command fields corresponds to one control resource set pool index for updating the TA. In the case that a TRP is identified using the control resource set pool index, the TA values corresponding to different TRPs can be adjusted based on the MAC CE of this structure.

There are two different implementations, namely an implementation 1.1.1 and an implementation 1.1.2, for a corresponding relationship between the TA command field in the first MAC CE and the control resource set pool index.

The implementation 1.1.1: The corresponding relationship between the TA command field and the control resource set pool index is predefined.

That is, corresponding relationships between the m TA command fields in the first MAC CE and m control resource set pool indexes are predefined.

In some embodiments, an i^{th} TA command field in the m TA command fields corresponds to an i^{th} control resource set pool index, wherein i is greater than or equal to 1 and less than or equal to m.

For example, m is 2. A 1^{st} TA command field corresponds to a 1^{st} control resource set pool index CORESETPoolIndex 0, and a 2^{nd} TA command field corresponds to a 2^{nd} control resource set pool index CORESETPoolIndex 1.

In some embodiments, the i^{th} TA command field in the m TA command fields corresponds to an (m−i+1)^{th} control resource set pool index, whererein i is greater than or equal to 1 and less than or equal to m.

For example, m is 2. The 1^{st} TA command field corresponds to the 2^{nd} control resource set pool index CORESETPoolIndex 1. The 2^{nd} TA command field corresponds to the 1^{st} control resource set pool index CORESETPoolIndex 0.

Because the TA update in the embodiments of the present disclosure includes the difference-based TA update and the absolute value-based TA update, the first MAC CE in the embodiments of the present disclosure may correspond to a differential adjustment format of a TA or an absolute value adjustment format of a TA. The following describes the implementation 1.1.1 based on two exemplary MAC CE formats.

For example, the first MAC CE corresponds to the differential adjustment format of the TA.

As illustrated in FIG. 7, the MAC CE provides two different TA commands for the same TAG. A TA command 1 (the 1^{st} one) corresponds to a TA update for CORESETPoolIndex 0 (the 1^{st} one). A TA command 2 (the 2^{nd} one) corresponds to a TA update for CORESETPoolIndex 1 (the 2^{nd} one). In this case, the first 2 bits in the 2^{nd} row of the MAC CE, namely R fields, may be considered as reserved bits.

It should be understood that FIG. 7 merely illustrates a format in which the MAC CE provides two different TA commands for description. The MAC CE may alternatively provide three or more different TA commands.

It should be understood that FIG. 7 merely illustrates a possible corresponding relationship between the TA command field and the control resource set pool index, which is not limited in the embodiments of the present disclosure.

For example, the first MAC CE corresponds to the absolute value adjustment format of the TA.

As illustrated in FIG. 8, the MAC CE provides two different TA commands for the same TAG. A TA command 1 (the 1^{st} one) corresponds to a TA update for CORESETPoolIndex 0 (the 1^{st} one). A TA command 2 (the 2^{nd} one) corresponds to a TA update for CORESETPoolIndex 1 (the 2^{nd} one). In this case, the absolute value-based TA update is applicable only to the PTAG, i.e., the TAG including the SpCell. Generally, a TAG ID is 0. Therefore, the TAG ID does not need to be provided in the MAC CE.

It should be understood that FIG. 8 merely illustrates a format in which the MAC CE provides two different TA commands for description. The MAC CE may alternatively provide three or more different TA commands.

It should be understood that FIG. 8 merely illustrates a possible corresponding relationship between the TA command field and the control resource set pool index, which is not limited in the embodiments of the present disclosure.

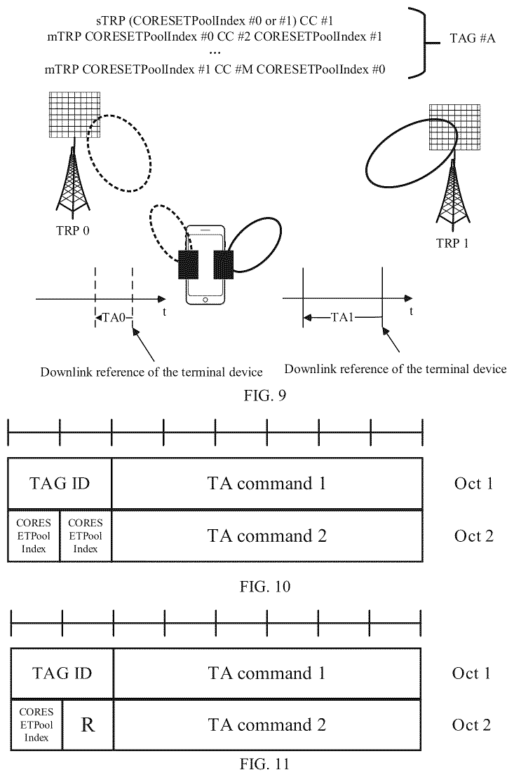

In some embodiments, FIG. 9 is a schematic diagram of a TA update for mDCI-mTRP.

The terminal device has two different RF links to adjust two TA parameters, marked by a dashed line and a solid line respectively. The network device determines, based on a time when an uplink signal transmitted by the terminal device, such as an SRS, arrives at the network device, a TA adjustment amount that needs to be corrected by the terminal device.

In addition, one TAG may include a plurality of component carriers (CCs). Each of the plurality of CCs may be an sTRP operation or an mTRP operation. In the case that the CC is the sTRP operation, CORESETPoolIndex values for CORESETs are either all 0 or all 1, as illustrated by CC #1 in FIG. 9. In the case that the CORESETPoolIndex is not configured, the CORESETPoolIndex value is defaulted to 0. With respect to CORESETPoolIndex configurations on CCs, in the case that the mTRP operation is performed, CORESETPoolIndex configurations on a plurality of CCs should be consistent. For example, CORESETPoolIndex #0 is configured for a TRP 0 and CORESETPoolIndex #1 is configured for a TRP 1. In the case that the CORESETPoolIndex configurations on the plurality of CCs are inconsistent, as illustrated by CORESETPoolIndex of CC #M in FIG. 9, CORESETPoolIndex #1 is configured for the TRP 0 and CORESETPoolIndex #0 is configured for the TRP 1. Consequently, the terminal device transmits an uplink channel and signal to the TRP 1 with a TA indicated to the TRP 0, thereby resulting in an error.

In the case of carrier aggregation (CA) as illustrated in FIG. 9, in the caset that the network device needs to assign different CORESETPoolIndex values to the TRP 0 or the TRP 1, the embodiments of the present disclosure suggest that CCs with inconsistent CORESETPoolIndex configurations are allocated to different TAGs, that is, one TRP in one TAG uses only one CORESETPoolIndex value.

The implementation 1.1.2: The first MAC CE further includes a control resource set pool index indicator field. The control resource set pool index indicator field indicates the corresponding relationship between the TA command field and the control resource set pool index.

That is, the first MAC CE further includes the control resource set pool index indicator field, wherein the control resource set pool index indicator field indicates the corresponding relationship between the TA command field and the control resource set pool index, thereby enhancing TA update flexibility.

In some embodiments, m control resource set pool index indicator fields are defined. Each of the m control resource set pool index indicator fields carries one control resource set pool index. The corresponding relationship between the control resource set pool index indicator field and the TA command field is predefined.

Values of the m control resource set pool index indicator fields are different from each other.

In some embodiments, an i^{th} control resource set pool index indicator field in the m control resource set pool index indicator fields indicates the control resource set pool index corresponding to the i^{th} TA command field, wherein i is greater than or equal to 1 and less than or equal to m.

For example, m is 2. In the case that the value of a 1^{st} control resource set pool index indicator field is CORESETPoolIndex 1, a 1^{st} TA command field corresponds to CORESETPoolIndex 1. In the case that the value of a 2^{nd} control resource set pool index indicator field is CORESETPoolIndex 0, a 2^{nd} TA command field corresponds to CORESETPoolIndex 0.

In some embodiments, the i^{th} control resource set pool index indicator field in the m control resource set pool index indicator fields indicates the control resource set pool index corresponding to an (m−i+1)^{th} TA command field, wherein i is greater than or equal to 1 and less than or equal to m.

For example, m is 2. In the case that the value of the 1^{st} control resource set pool index indicator field is CORESETPoolIndex 1, the 2^{nd} TA command field corresponds to CORESETPoolIndex 1. In the case that the value of the 2^{nd} control resource set pool index indicator field is CORESETPoolIndex 0, the 1^{st} TA command field corresponds to CORESETPoolIndex 0.

In some embodiments, one control resource set pool index indicator field is defined. A codepoint corresponding to the control resource set pool index indicator field indicates the corresponding relationship between the TA command field and the control resource set pool index.

For example, m is 2. In the case that the codepoint of the control resource set pool index indicator field is 0, the 1^{st} TA command field corresponds to CORESETPoolIndex 0, and the 2nd TA command field corresponds to CORESETPoolIndex 1. In the case that the codepoint of the control resource set pool index indicator field is 1, the 1^{st} TA command field corresponds to CORESETPoolIndex 1, and the 2^{nd} TA command field corresponds to CORESETPoolIndex 0.

Because the TA update in the embodiments of the present disclosure includes the difference-based TA update and the absolute value-based TA update, the first MAC CE in the embodiments of the present disclosure may correspond to a differential adjustment format of a TA or an absolute value adjustment format of a TA. The following describes the implementation 1.1.2 based on four exemplary MAC CE formats.

For example, the first MAC CE corresponds to the differential adjustment format of the TA.

As illustrated in FIG. 10, the MAC CE provides two different TA commands for the same TAG, and uses the first 2 bits in the 2^{nd} row to represent two CORESETPoolIndex values, namely a CORESETPoolIndex value corresponding to a TA command 1 and a CORESETPoolIndex value corresponding to a TA command 2. The TA command 1 (the 1^{st} one) corresponds to a TA update for the CORESETPoolIndex value of the 1^{st} bit. The TA command 2 (the 2^{nd} one) corresponds to a TA update for the CORESETPoolIndex value of the 2^{nd} bit. In this case, in the case that the CORESETPoolIndex value of the 1^{st} bit is 1 and the CORESETPoolIndex value of the 2^{nd} bit is 0, the TA command 1 (the 1^{st} one) can correspond to a TA update for CORESETPoolIndex 1 and the TA command 2 (the 2^{nd} one) can correspond to a TA update for CORESETPoolIndex 0.

It should be understood that FIG. 10 merely illustrates a format in which the MAC CE provides two different TA commands for description. The MAC CE may alternatively provide three or more different TA commands.

It should be understood that FIG. 10 merely illustrates a possible corresponding relationship between the TA command field and the control resource set pool index indicator field, which is not limited in the embodiments of the present disclosure.

As illustrated in FIG. 11, the MAC CE provides two different TA commands for the same TAG, and uses the 1^{st} bit in the 2^{nd} row as the control resource set pool index indicator field and the 2^{nd} bit in the 2^{nd} row as a reserved bit. In this case, in the case that the 1^{st} bit is 0, a TA command 1 can correspond to a TA update for CORESETPoolIndex 0 and a TA command 2 can correspond to a TA update for CORESETPoolIndex 1. In the case that the 1^{st} bit is 1, the TA command 1 corresponds to a TA update for CORESETPoolIndex 1, and the TA command 2 corresponds to a TA update for CORESETPoolIndex 0.

It should be understood that FIG. 11 merely illustrates a format in which the MAC CE provides two different TA commands for description. The MAC CE may alternatively provide three or more different TA commands.

It should be understood that FIG. 11 merely illustrates a possible technical solution of indicating the corresponding relationship between the TA command field and the control resource set pool index based on a codepoint, which is not limited in the embodiments of the present disclosure.

For example, the first MAC CE corresponds to the absolute value adjustment format of the TA.

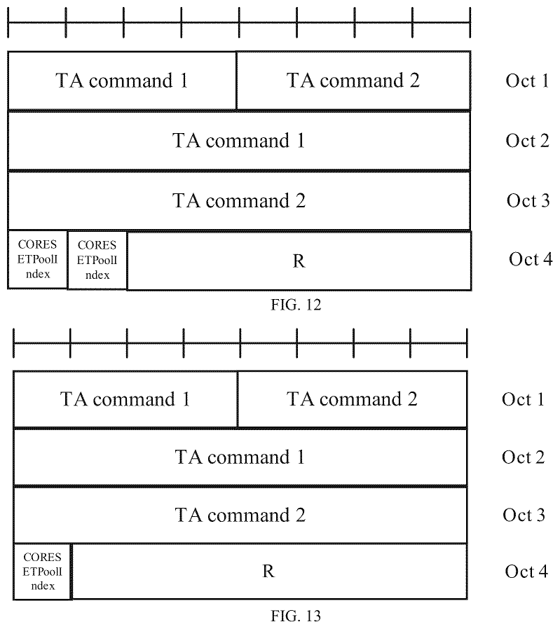

As illustrated in FIG. 12, the MAC CE provides two different TA commands for the same TAG, and uses the first 2 bits in the 4th row to represent two CORESETPoolIndex values, namely a CORESETPoolIndex value corresponding to a TA command 1 and a CORESETPoolIndex value corresponding to a TA command 2. The TA command 1 (the 1^{st} one) corresponds to a TA update for the CORESETPoolIndex value of the 1^{st} bit. The TA command 2 (the 2^{nd} one) corresponds to a TA update for the CORESETPoolIndex value of the 2^{nd} bit. In this case, in the case that the CORESETPoolIndex value of the 1^{st} bit is 1 and the CORESETPoolIndex value of the 2^{nd} bit is 0, the TA command 1 (the 1^{st} one) corresponds to a TA update for CORESETPoolIndex 1, and the TA command 2 (the 2^{nd} one) corresponds to a TA update for CORESETPoolIndex 0.

It should be understood that FIG. 12 merely illustrates a format in which the MAC CE provides two different TA commands for description. The MAC CE may alternatively provide three or more different TA commands.

It should be understood that FIG. 12 merely illustrates a possible corresponding relationship between the TA command field and the control resource set pool index indicator field, which is not limited in the embodiments of the present disclosure.

As illustrated in FIG. 13, the MAC CE provides two different TA commands for the same TAG, and uses the 1^{st} bit in the 4th row as the control resource set pool index indicator field and the other bits in the 4th row as reserved bits. In this case, in the case that the 1^{st} bit is 0, a TA command 1 can correspond to a TA update for CORESETPoolIndex 0 and a TA command 2 can correspond to a TA update for CORESETPoolIndex 1. In the case that the 1^{st} bit is 1, the TA command 1 corresponds to a TA update for CORESETPoolIndex 1, and the TA command 2 corresponds to a TA update for CORESETPoolIndex 0.

It should be understood that FIG. 13 merely illustrates a format in which the MAC CE provides two different TA commands for description. The MAC CE may alternatively provide three or more different TA commands.

It should be understood that FIG. 13 merely illustrates a possible technical solution of indicating the corresponding relationship between the TA command field and the control resource set pool index based on a codepoint, which is not limited in the embodiments of the present disclosure.

The implementation 2.1: One MAC CE indicates a TA value corresponding to one TRP.

In this implementation, the downlink signaling is a second MAC CE. The second MAC CE is applicable to the mDCI-mTRP uplink transmission scenario. The second MAC CE includes a TAG ID field. A TAG ID in the TAG ID field corresponds to one control resource set pool index. The control resource set pool index corresponds to one TRP.

In this implementation, a plurality of TAGs are configured for one serving cell. Then, a TA value is updated for each of the plurality of TAGs based on a MAC CE in an existing format. In this way, the terminal device can have different TA values, namely different transmission timelines, for a plurality of TRPs in one serving cell.

Because the TA update in the embodiments of the present disclosure includes the difference-based TA update and the absolute value-based TA update, the second MAC CE in the embodiments of the present disclosure may correspond to a differential adjustment format of a TA or an absolute value adjustment format of a TA. For details about a format of the second MAC CE, reference may be made to an existing MAC CE format, such as FIG. 1 and FIG. 2, which are not described herein any further.

In some embodiments, a corresponding relationship between the TAG ID and the control resource set pool index is predetermined; or a corresponding relationship between the TAG ID and the control resource set pool index is configured by the network device.

In some embodiments, one serving cell is configured with two TAGs. For example, in the case that a serving cell has been configured with a tag-Id, a tag-Id2 is added for the serving cell. TAG-Id values configured for the tag-Id2 and the tag-Id should be different. A RRC configuration in this solution is as follows.

| | |
|---|---|
| ServingCellConfig ::= | SEQUENCE { |

tdd-UL-DL-ConfigurationDedicated TDD-UL-DL-ConfigDedicated
OPTIONAL, -- Cond TDD

| | |
|---|---|
| initialDownlink | BWPBWP-DownlinkDedicated |

OPTIONAL, -- Need M

| | |
|---|---|
| downlinkBWP-ToReleaseList | SEQUENCE (SIZE (1..maxNrofBWPs)) OF BWP-Id |

OPTIONAL, -- Need N

| | |
|---|---|
| downlinkBWP-ToAddModList | SEQUENCE (SIZE (1..maxNrofBWPs)) OF |
| BWP-Downlink | OPTIONAL, -- Need N |
| firstActiveDownlink | BWP-IdBWP-Id |

OPTIONAL, -- Cond SyncAndCellAdd

| | |
|---|---|
| bwp-InactivityTimer | ENUMERATED {ms2, ms3, ms4, ms5, ms6, ms8, ms10, ms20, |

ms30,

```
  ms40,ms50, ms60, ms80,ms100, ms200,ms300, ms500,
ms750, ms1280, ms1920, ms2560, spare10, spare9, spare8,
  spare7, spare6, spare5, spare4, spare3, spare2, spare1 }
```

OPTIONAL, --Need R

| | |
|---|---|
| defaultDownlink | BWP-IdBWP-Id |

OPTIONAL, -- Need S

| | |
|---|---|
| uplinkConfig | UplinkConfig |

OPTIONAL, -- Need M

| | |
|---|---|
| Supplementary | UplinkUplinkConfig |

OPTIONAL, -- Need M

| | |
|---|---|
| pdcch-ServingCell | SetupRelease{PDCCH-ServingCellConfig} |

OPTIONAL, -- Need M

| | |
|---|---|
| pdsch-ServingCellConfig | SetupRelease{PDSCH-ServingCellConfig} |

OPTIONAL, -- Need M

| | |
|---|---|
| csi-MeasConfig | SetupRelease{CSI-MeasConfig} |

OPTIONAL, -- Need M

| | |
|---|---|
| sCellDeactivationTimer | ENUMERATED {ms20, ms40, ms80, ms160, ms200, |

ms240,

```
      ms320, ms400, ms480, ms520, ms640, ms720,
      ms840, ms1280, spare2,spare1} OPTIONAL, -- Cond
```

ServingCellWithoutPUCCH

| | |
|---|---|
| CrossCarrierSchedulingConfig | CrossCarrierSchedulingConfig |
| OPTIONAL, -- Need M | |
| tag-Id | TAG-Id, |
| tag-Id2 | TAG-Id, |
| dummy1 | ENUMERATED{enabled} |

OPTIONAL, -- Need R

| | |
|---|---|
| PathlossReferenceLinking | ENUMERATED{spCell,sCell} |

OPTIONAL, -- Cond SCellOnly

| | |
|---|---|
| ServingCellMO | MeasObjectId |

```
OPTIONAL, -- Cond MeasObject
    ...,
    [[
```

| | |
|---|---|
| lte-CRS-ToMatchAround | SetupRelease{RateMatchPatternLTE-CRS} |

OPTIONAL, -- Need M

| | |
|---|---|
| rateMatchPatternToAddModList | SEQUENCE (SIZE (1..maxNrofRateMatchPatterns)) OF |

RateMatchPattern
OPTIONAL, -- Need N

| | |
|---|---|
| rateMatchPatternToReleaseList | SEQUENCE (SIZE (1..maxNrofRateMatchPatterns)) OF |

RateMatchPatternId
OPTIONAL, -- Need N

| | |
|---|---|
| downlinkChannelBW-PerSCS-List | SEQUENCE (SIZE (1..maxSCSs)) OF |
| SCS-SpecificCarrier | OPTIONAL -- Need S |

```
    ]],
    [[
```

| | |
|---|---|
| supplementaryUplinkRelease-r16 | ENUMERATED{true} |

OPTIONAL, -- Need N
tdd-UL-DL-ConfigurationDedicated-IAB-MT-r16

| | |
|---|---|
| TDD-UL-DL-ConfigDedicated-IAB-MT-r16 | OPTIONAL, -- Cond TDD_IAB |
| dormantBWP-Config-r16 | SetupRelease{DormantBWP-Config-r16} |

OPTIONAL, -- Need M

| | |
|---|---|
| ca-SlotOffset-r16 | CHOICE { |
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |
| } | OPTIONAL, -- Cond |

AsyncCA

| | |
|---|---|
| dummy2 | SetupRelease{DummyJ} |

OPTIONAL, -- Need M

| | |
|---|---|
| intraCellGuardBandsDL-List-r16 | EQUENCE (SIZE (1..maxSCSs)) OF |

IntraCellGuardBandsPerSCS-r16
OPTIONAL, -- Need S

| | |
|---|---|
| intraCellGuardBandsUL-List-r16 | SEQUENCE (SIZE (1..maxSCSs)) OF |

IntraCellGuardBandsPerSCS-r16
OPTIONAL, -- Need S

| | |
|---|---|
| csi-RS-Validation WithDCI-r16 | ENUMERATED{enabled} |

OPTIONAL, -- Need R

| | |
|---|---|
| lte-CRS-PatternList1-r16 | SetupRelease{LTE-CRS-PatternList-r16} |

OPTIONAL, -- Need M

| | |
|---|---|
| lte-CRS-PatternList2-r16 | SetupRelease{LTE-CRS-PatternList-r16} |

OPTIONAL, -- Need M

| | |
|---|---|
| crs-RateMatch-PerCORESETPoolIndex-r16 | ENUMERATED{enabled} |

OPTIONAL, -- Need R

| | |
|---|---|
| enableTwoDefaultTCI-States-r16 | ENUMERATED{enabled} |

OPTIONAL, -- Need R
enableDefaultTCI-StatePerCoresetPoolIndex-r16 ENUMERATED{enabled}
OPTIONAL, -- Need R

| | |
|---|---|
| enableBeamSwitchTiming-r16 | ENUMERATED{true} |

OPTIONAL, -- Need R

| | |
|---|---|
| cbg-TxDiffTBsProcessingType1-r16 | ENUMERATED{enabled} |

OPTIONAL, -- Need R

| | |
|---|---|
| cbg-TxDiffTBsProcessingType2-r16 | ENUMERATED{enabled} |

```
OPTIONAL -- Need R
    ]],
    [[
```

| | |
|---|---|
| directionalCollisionHandling-r16 | ENUMERATED{enabled} |

OPTIONAL, -- Need R

| | |
|---|---|
| channelAccessConfig-r16 | SetupRelease{ChannelAccessConfig-r16} |

OPTIONAL -- Need M
]]
}

In the foregoing RRC configuration, there are two possible corresponding relationships of CORESETPoolIndex with the tag-Id and the tag-Id2.

The first corresponding relationship is prescribed. For example, a TA value (whether absolute or differential) of the tag-Id corresponds to a TRP of CORESETPoolIndex 0, and a TA value (whether absolute or differential) of the tag-Id2 corresponds to a TRP of CORESETPoolIndex 1, or vice versa.

The second corresponding relationship may be configured based on a RRC configuration. That is, the network device configures a corresponding CORESETPoolIndex value for the tag-Id and/or the tag-Id2 during the RRC configuration. For example:

| tag-Id | TAG-Id, | |
|---|---|---|
| coresetPoolIndex | INTEGER (0..1) | OPTIONAL, -- Need S |
| tag-Id2 | TAG-Id, | |
| coresetPoolIndex2 | INTEGER (0..1) | OPTIONAL, -- Need S |

In summary, in the method for indicating the TA according to these embodiments, the network device transmits the downlink signaling to the terminal device. The downlink signaling indicates the at least one TA. Each of the at least one TA corresponds to one TRP. Correspondingly, the terminal device updates the at least one TA. In this way, the terminal device is capable of adjusting the TA values corresponding to different TRPs, such that each of the TRPs is capable of receiving uplink transmission from the terminal device at an appropriate time point.

In addition, in the method for indicating the TA according to these embodiments, the TA is updated based on a MAC CE in a changed format, which is an enhancement to a traditional TA update method.

2. sDCI-mTRP uplink transmission scenario: a TA update solution associated with an SRS resource set, in which the TA is updated as instructed by the DCI as the downlink signaling.

The implementation 1.2: One piece of DCI indicates the TA values corresponding to the plurality of TRPs.

In this implementation, the downlink signaling is DCI. The DCI is applicable to the sDCI-mTRP uplink transmission scenario. The DCI includes an SRS resource set field. The SRS resource set field corresponds to a first codepoint. The first codepoint indicates m TA values associated with m SRS resource sets. Each SRS resource set corresponds to one TRP.

In this implementation, a plurality of codepoints are configured for the SRS resource set field using the SRS resource set field in the uplink scheduling DCI. In addition, the m TA values associated with the m SRS resource sets indicated by different codepoints are different. In the case that a TRP is identified by an SRS resource set, the SRS resource set field in the DCI corresponds to the first codepoint in the plurality of codepoints, and the first codepoint indicates the m TA values associated with the m SRS resource sets, the TA values corresponding to different TRPs can be adjusted based on the DCI.

In some embodiments, a first SRS resource set in the m SRS resource sets corresponds to at least one activated TA value. The TA value associated with the first SRS resource set is one of the at least one activated TA value.

It should be understood that the first SRS resource set is any one of the m SRS resource sets. That is, each of the m SRS resource sets corresponds to a plurality of activated TA values. In addition, the sequence of the plurality of activated TA values follows a specific rule. The first codepoint of the SRS resource set field indicate which TA value in the activated TA values is associated with each SRS resource set in the m SRS resource sets.

In some embodiments, the TA values corresponding to each of the m SRS resource sets are activated or deactivated using a MAC CE.

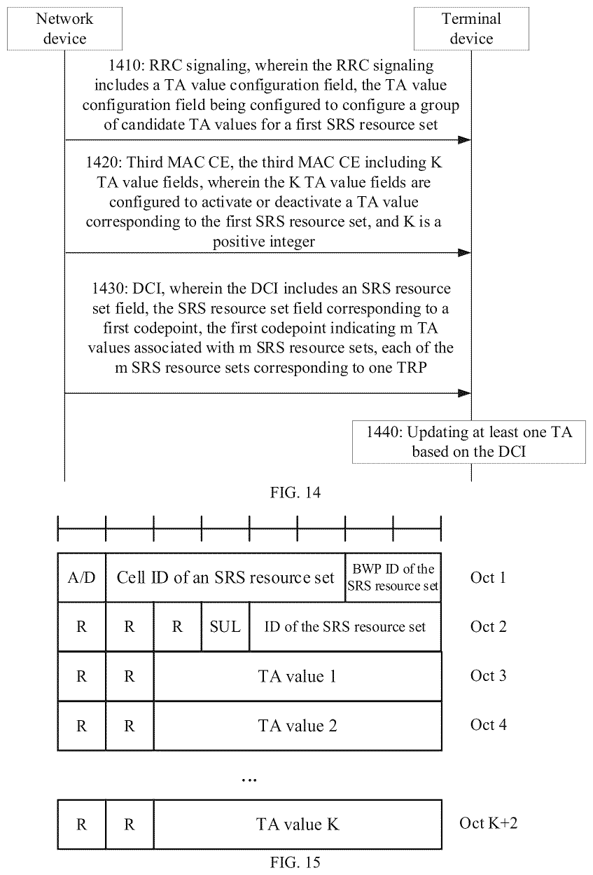

Referring to FIG. 14, prior to receiving the DCI transmitted by the network device in process 1430, the terminal device receives a third MAC CE in process 1420. The third MAC CE includes K TA value fields. The K TA value fields are defined to activate or deactivate the TA value corresponding to the first SRS resource set. K is a positive integer.

In addition, to reduce overhead of MAC CE signaling, TA activation/deactivation commands of a plurality of SRS resource sets may be aggregated in one MAC CE.

In some embodiments, the first SRS resource set in the m SRS resource sets corresponds to at least one candidate TA value. The network device selects the at least one activated TA value corresponding to the first SRS resource set from the at least one candidate TA value.

It should be understood that the first SRS resource set is any one of the m SRS resource sets. That is, each of the m SRS resource sets corresponds to its own candidate TA values. At least one activated TA value corresponding to each of the m SRS resource sets is selected from the at least one candidate TA value.

In some embodiments, the at least one candidate TA value corresponding to each of the m SRS resource sets is configured using RRC signaling.

Referring to FIG. 14, prior to receiving the third MAC CE transmitted by the network device in process 1420, the terminal device receives the RRC signaling in process 1410. The RRC signaling includes a TA value configuration field, wherein the TA value configuration filed is defined to configure a group of candidate TA values for the first SRS resource set.

In addition, the candidate TA values may include at least one of differential adjustment values of M TAs or absolute adjustment values of N TAs. M and N are positive integers greater than 1. M and N are the same or different.

The following provides an example to describe a method for indicating a TA corresponding to the implementation 1.2. In this example, the following three processes are involved.

(1) Each of the m SRS resource sets is configured with a plurality of candidate TA values based on RRC signaling.

The candidate TA values may be difference-based or absolute value-based. Specific RRC signaling is as follows.

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS-ResourcesPerSet)) OF |

SRS-ResourceId OPTIONAL, -- Cond Setup

| | |
|---|---|
| resource Type | CHOICE { |
| aperiodic | SEQUENCE { |

aperiodicSRS-ResourceTrigger INTEGER (1..maxNrofSRS-TriggerStates−1),

| | |
|---|---|
| csi-RS | NZP-CSI-RS-ResourceId OPTIONAL, -- Cond NonCodebook |
| slotOffset | INTEGER (1..32) OPTIONAL, -- Need S |

```
        ...,
        [[
```

| | |
|---|---|
| aperiodicSRS-ResourceTriggerList | SEQUENCE |

(SIZE(1..maxNrofSRS-TriggerStates−2))

OF INTEGER (1..maxNrofSRS-TriggerStates−1)

```
OPTIONAL -- Need M
          ]]
        },
```

| | |
|---|---|
| semi-persistent | SEQUENCE { |
| associatedCSI-RS | NZP-CSI-RS-ResourceId OPTIONAL, -- Cond |

```
NonCodebook
            ...
        },
```

| | |
|---|---|
| periodic | SEQUENCE { |
| associatedCSI-RS | NZP-CSI-RS-ResourceId OPTIONAL, -- Cond |

```
NonCodebook
          ...
        }
    },
```

| | |
|---|---|
| usage | ENUMERATED {beamManagement, codebook, nonCodebook, |

antennaSwitching},

| | |
|---|---|
| alpha Alpha | OPTIONAL, -- Need S |
| p0 INTEGER (−202..24) | OPTIONAL, -- Cond Setup |
| pathlossReferenceRS PathlossReferenceRS-Config | OPTIONAL, -- Need M |
| srs-PowerControlAdjustmentStates | ENUMERATED { sameAsFci2, |
| separateClosedLoop} | OPTIONAL, -- Need S |

```
    ...,
    [[
```

| | |
|---|---|
| pathlossReferenceRSList-r16 | SetupRelease { PathlossReferenceRSList-r16} |

```
OPTIONAL -- Need M
    ]],
    [[
```

| | |
|---|---|
| availableSlotOffsetList-r17 | SEQUENCE (SIZE(1..4)) OF AvailableSlotOffset-r17 |

OPTIONAL, -- Need R

| | |
|---|---|
| followUnifiedTCIstateSRS-r17 | ENUMERATED{enabled} OPTIONAL -- Need |

```
R
  ]]
  [[
```

| | |
|---|---|
| TADifferentialValue | SEQUENCE (SIZE(1..M)) OF TADiff |

OPTIONAL

| | |
|---|---|
| TAAbsoluteValue | SEQUENCE (SIZE(1..N)) OF TAAbs |

```
    OPTIONAL
  ]]
}
TADiff = {0, 1, 2, ..., 63}
TAAbs = {0, 1, 2, ..., 3846}
```

As illustrated above, in each SRS resource set configured with uplink transmission use (codebook-based or non-codebook-based), one group of (M) differential adjustment values of TAs and one group of (N) absolute value adjustment values of TAs are selectively configured.

(2) A plurality of TA values are activated or deactivated for each of the m SRS resource sets based on a MAC CE.

With respect to activation or deactivation of difference-based TA values, reference may be made to FIG. 15 for signaling design of the MAC CE. Each field is described as follow.

A/D: This field indicates whether to activate or deactivate an indicated periodic (SP) SRS resource set. The field is set to 1 indicate activation, otherwise to indicate deactivation. In the case that an indicated SRS resource set ID is for an aperiodic (AP) SRS resource set, a MAC entity ignores this field.

Cell ID of the SRS resource set: This field indicates an identity of a serving cell, wherein the serving cell including the indicated SP/AP SRS resource set. In the case that a C field is set to 0, the C field further indicates an identity of a serving cell, wherein the serving cell including all resources indicated by a resource IDi field. The Cell ID of the SRS resource set field is 5 bits in length.

Bandwidth part (BWP) ID of the SRS resource set: This field indicates an uplink BWP as a codepoint of a DCI BWP indicator field, which contains the indicated SP/AP SRS resource set. This field is 2 bits in length.

Supplementary uplink (SUL) carrier: This field indicates whether a MAC CE is applicable to normal uplink (NUL) carrier or SUL carrier configurations. This field is set to 1 to indicate that the MAC CE is applicable to the SUL carrier configuration and 0 to indicate that the MAC CE is applicable to the NUL carrier configuration.

SRS resource set ID: This field indicates the SP/AP SRS resource set ID identified by SRS-ResourceSetId. This field is 4 bits in length.

TA value K: This field indicates a K^{th} activated/deactivated TA value for the SRS resource set.

For example, activated/deactivated TA values corresponding to one SRS resource set may be TA={29, 31, 33, 35}. Differential TAs are calculated using the following formula:

$${N}_{( {TA}_{new} )} = {N}_{( {TA}_{old} )} + ( {T}_{A} - 31 ) * 16 * 64 * / {2}^{μ}$$

Therefore, differential adjustment amounts of the TAs can be acquired as {−2, 0, 2, 4}, including forward or backward adjustment of the TAs in time domain, and retention after TA adjustment (that is, a TA differential value is 0).

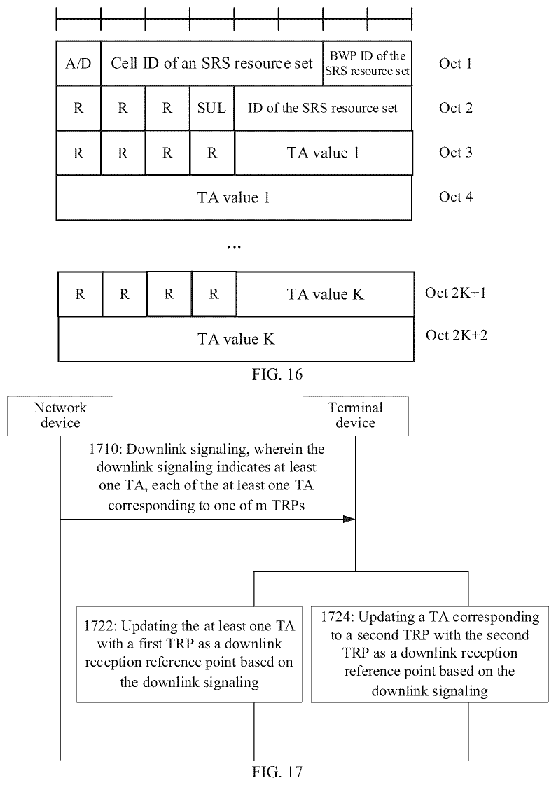

With respect to activation or deactivation of absolute value-based TA values, reference may be made to FIG. 16 for signaling design of the MAC CE. For details about each field, reference may be made to FIG. 15 similarly, which are not described herein any further.

In addition, an absolute TA value in FIG. 16 is 12 bits in length. For example, the activated TA values may be {0, 4, 8, 16, 32, 64, 128, 256} and the like. A maximum value does not exceed 3846, which is a maximum value supported in an NR system at present.

(3) The TA is adjusted based on an SRS resource set field in DCI.

During uplink dynamic scheduling, the network device may indicate PUSCH transmission for sTRP or PUSCH repetitions for mTRP based on the SRS resource set field in the DCI. With respect to specific meanings, reference may be made to Table 2 formulated in a standardization process:

TABLE 2

| | | SRI (codebook-based and |
|---|---|---|
| | | non-codebook-based)/TPMI |
| Codepoint | SRS resource set(s) | (codebook-based only) field(s) |
| 00 | sTRP mode: | First SRI/TPMI field (a second field |
| | First SRS resource set | unused) |
| | (representing a TRP 1) | |
| 01 | sTRP mode: | First SRI/TPMI field (a second field |
| | Second SRS resource set | unused) |
| | (representing a TRP 2) | |
| 10 | mTRP mode (TRP 1 and TRP 2 in | First and second SRI/TPMI fields |
| | sequence) | |
| | First SRI/TPMI field: first SRS | |
| | resource set | |
| | Second SRI/TPMI field: second | |
| | SRS resource set | |
| 11 | mTRP mode (TRP 2 and TRP 1 in | First and second SRI/TPMI fields |
| | sequence) | |
| | First SRI/TPMI field: first SRS | |
| | resource set | |
| | Second SRI/TPMI field: second | |
| | SRS resource set | |

In the embodiments of the present disclosure, an extended SRS resource set mapping table is designed based on Table 2. Different codepoints correspond to different combinations of TA values, thereby dynamically indicating TA adjustment of TRP(s) along with uplink scheduling sTRP or mTRP transmission.

It should be understood that an advantage is that no additional field is added to the DCI. Taking the difference-based TA update as an example, to express four differential TA values, a quantity of codepoints in the SRS resource set field needs to be increased from 4 to 8, and the expanded SRS resource set mapping table is listed in Table 3.

TABLE 3

| | | SRI (codebook-based and | |
|---|---|---|---|
| Code- | | non-codebook-based)/TPMI | |
| point | SRS resource set(s) | (codebook-based only) field(s) | TA value |
| 0000 | sTRP mode: | First SRI/TPMI field (a | The first SRS resource |
| | First SRS resource set | second field unused) | set (representing the |
| | (representing a TRP 1) | | TRP 1) is associated |
| | | | with the 1^{st} activated |
| | | | TA value |
| 0001 | sTRP mode: | First SRI/TPMI field (a | The first SRS resource |
| | First SRS resource set | second field unused) | set (representing the |
| | (representing a TRP 1) | | TRP 1) is associated |
| | | | with the 2^{nd} activated |
| | | | TA value |
| 0010 | sTRP mode: | First SRI/TPMI field (a | The first SRS resource |
| | First SRS resource set | second field unused) | set (representing the |
| | (representing a TRP 1) | | TRP 1) is associated |
| | | | with the 3^{rd} activated |
| | | | TA value |
| 0011 | sTRP mode: | First SRI/TPMI field (a | The first SRS resource |
| | First SRS resource set | second field unused) | set (representing the |
| | (representing a TRP 1) | | TRP 1) is associated |
| | | | with the 4^{th} activated |
| | | | TA value |
| 0100 | sTRP mode: | First SRI/TPMI field (a | The second SRS resource |
| | Second SRS resource | second field unused) | set (representing the |
| | set (representing a | | TRP 2) is associated |
| | TRP 2) | | with the 1^{st} activated |
| | | | TA value |
| 0101 | sTRP mode: | First SRI/TPMI field (a | The second SRS resource |
| | Second SRS resource | second field unused) | set (representing the |
| | set (representing a | | TRP 2) is associated |
| | TRP 2) | | with the 2^{nd} activated |
| | | | TA value |
| 0110 | sTRP mode: | First SRI/TPMI field (a | The second SRS resource |
| | Second SRS resource | second field unused) | set (representing the |
| | set (representing a | | TRP 2) is associated |
| | TRP 2) | | with the 3^{rd} activated |
| | | | TA value |
| 0111 | sTRP mode: | First SRI/TPMI field (a | The second SRS resource |
| | Second SRS resource | second field unused) | set (representing the |
| | set (representing a | | TRP 2) is associated |
| | TRP 2) | | with the 4^{th} activated |
| | | | TA value |
| 1000 | mTRP mode (TRP 1 and | First and second SRI/TPMI | The first SRS resource |
| | TRP 2 in sequence) | fields | set (representing the |
| | First SRI/TPMI field: | | TRP 1) is associated |
| | first SRS resource set | | with the 1^{st} activated |
| | Second SRI/TPMI field: | | TA value |
| | second SRS resource set | | The second SRS resource |
| | | | set (representing the |
| | | | TRP 2) is associated |
| | | | with the 1^{st} activated |
| | | | TA value |
| 1001 | mTRP mode (TRP 1 and | First and second SRI/TPMI | The first SRS resource |
| | TRP 2 in sequence) | fields | set (representing the |
| | First SRI/TPMI field: | | TRP 1) is associated |
| | first SRS resource set | | with the 1^{st} activated |
| | Second SRI/TPMI field: | | TA value |
| | second SRS resource set | | The second SRS resource |
| | | | set (representing the |
| | | | TRP 2) is associated |
| | | | with the 2^{nd} activated |
| | | | TA value |
| 1010 | mTRP mode (TRP 1 and | First and second SRI/TPMI | The first SRS resource |
| | TRP 2 in sequence) | fields | set (representing the |
| | First SRI/TPMI field: | | TRP 1) is associated |
| | first SRS resource set | | with the 2^{nd} activated |
| | Second SRI/TPMI field: | | TA value |
| | second SRS resource set | | The second SRS resource |
| | | | set (representing the |
| | | | TRP 2) is associated |
| | | | with the 1^{st} activated |
| | | | TA value |
| 1011 | mTRP mode (TRP 1 and | First and second SRI/TPMI | The first SRS resource |
| | TRP 2 in sequence) | fields | set (representing the |
| | First SRI/TPMI field: | | TRP 1) is associated |
| | first SRS resource set | | with the 2^{nd} activated |
| | Second SRI/TPMI field: | | TA value |
| | second SRS resource set | | The second SRS resource |
| | | | set (representing the |
| | | | TRP 2) is associated |
| | | | with the 2^{nd} activated |
| | | | TA value |
| 1100 | mTRP mode (TRP 2 and | First and second SRI/TPMI | The first SRS resource |
| | TRP 1 in sequence) | fields | set (representing the |
| | First SRI/TPMI field: | | TRP 1) is associated |
| | first SRS resource set | | with the 3^{rd} activated |
| | Second SRI/TPMI field: | | TA value |
| | second SRS resource set | | The second SRS resource |
| | | | set (representing the |
| | | | TRP 2) is associated |
| | | | with the 3^{rd} activated |
| | | | TA value |
| 1101 | mTRP mode (TRP 2 and | First and second SRI/TPMI | The first SRS resource |
| | TRP 1 in sequence) | fields | set (representing the |
| | First SRI/TPMI field: | | TRP 1) is associated |
| | first SRS resource set | | with the 3^{rd} activated |
| | Second SRI/TPMI field: | | TA value |
| | second SRS resource set | | The second SRS resource |
| | | | set (representing the |
| | | | TRP 2) is associated |
| | | | with the 4^{th} activated |
| | | | TA value |
| 1110 | mTRP mode (TRP 2 and | First and second SRI/TPMI | The first SRS resource |
| | TRP 1 in sequence) | fields | set (representing the |
| | First SRI/TPMI field: | | TRP 1) is associated |
| | first SRS resource set | | with the 4^{th} activated |
| | Second SRI/TPMI field: | | TA value |
| | second SRS resource set | | The second SRS resource |
| | | | set (TRP 2) is associated |
| | | | with the 3^{rd} activated |
| | | | TA value |
| 1111 | mTRP mode (TRP 2 and | First and second SRI/TPMI | The first SRS resource |
| | TRP 1 in sequence) | fields | set (representing the |
| | First SRI/TPMI field: | | TRP 1) is associated |
| | first SRS resource set | | with the 4^{th} activated |
| | Second SRI/TPMI field: | | TA value |
| | second SRS resource set | | The second SRS resource |
| | | | set (representing the |
| | | | TRP 2) is associated |
| | | | with the 4^{th} activated |
| | | | TA value |

According to Table 3, the codepoints of the first 8 SRS resource sets correspond to sTRP transmission, such that a TA value of a single TRP (regardless of the TRP 1 or TRP 2) is adjusted. Herein, the 1^{st}, 2^{nd}, 3^{rd}, and 4^{th} activated TA values associated with the SRS resource sets are arranged from top to bottom in the MAC CE for activation/deactivation. For example, the 1^{st} TA value in the MAC CE is the 1^{st} activated TA, the 2^{nd} TA value in the MAC CE is the 2^{nd} activated TA, and so on.

The codepoints of the last 8 SRS resource sets correspond to mTRP transmission, such that each of the codepoints can simultaneously adjust TA values of 2 TRPs, that is, a combination of the TA values in the foregoing table. Considering that a TA combination is multiplied, only half of combinations are listed for the network device to adjust the TA.

In summary, in the method for indicating the TA according to these embodiments, the network device transmits the downlink signaling to the terminal device. The downlink signaling indicates the at least one TA. Each of the at least one TA corresponds to one TRP. Correspondingly, the terminal device updates the at least one TA. In this way, the terminal device can adjust the TA values corresponding to different TRPs, such that each of the TRPs can receive uplink transmission from the terminal device at an appropriate time point.

In addition, in the method for indicating the TA according to these embodiments, in the case that the terminal device moves fast, more dynamic signaling is needed to support timely TA adjustment. Therefore, the TA values of the terminal device for different TRPs are dynamically adjusted based on the SRS resource set field indicated in the DCI.

In some embodiments, the terminal device uses the same downlink reference point or different downlink reference points for the TAs of the plurality of TRPs.

FIG. 17 is a flowchart of a method for indicating a TA according to some embodiments of the present disclosure. The method may be applied to a communication system. The method may include the following processes.

In 1710, a network device transmits downlink signaling to a terminal device, wherein the downlink signaling indicates at least one TA, each of the at least one TA corresponding to one of m TRPs.

Correspondingly, the terminal device receives the downlink signaling, wherin the downlink signaling indicates the at least one TA, each of the at least one TA corresponding to one TRP.

In the embodiments of the present disclosure, a serving cell of the terminal device includes m TRPs, wherein m is a positive integer greater than or equal to 1.

For details about specific implementation of this process, reference may be made to process 410, which are not described herein any further.

In 1722, the terminal device updates the at least one TA with a first TRP as a downlink reception reference point based on the downlink signaling.

It should be understood that the first TRP is a specific SRS resource set in the m TRPs.

In an mTRP scenario, the terminal device may adjust the TA by using one of the plurality of TRPs as the downlink reception reference point, and advance a time corresponding to each of the plurality of TRPs by (N_{TA}+N_{TA,offset})*T_{C} starting from the downlink reception time point, to transmit an uplink channel or signal to each of the plurality of TRPs.

In some embodiments, the first TRP is predetermined; or the first TRP is configured by the network device.

For example, the first TRP is a predetermined TRP with CORESETPoolIndex 0.

For example, the first TRP is a TRP 0 configured by the network device.

In 1724, the terminal device updates a TA corresponding to a second TRP with the second TRP as a downlink reception reference point based on the downlink signaling.

It should be understood that the second TRP is any SRS resource set in the m TRPs.

In the mTRP scenario, the terminal device may adjust TAs by using different downlink reception reference points, and advance a time corresponding to any TRP by (N_{TA}+N_{TA,offset})*T_{C} starting from the downlink reception time point of the TRP, to transmit an uplink channel or signal to the TRP.

It should be understood that in process 1722, the first TRP is used as a single downlink reference point for downlink reception, and the premise thereof may be that the terminal device has only one downlink reception timeline. In process 1724, a plurality of different downlink reference points are used, and the premise thereof may be that the terminal device has a plurality of downlink reception timelines. A quantity of downlink reception timelines depends on a capability of the terminal device.

In summary, in the method for indicating the TA according to these embodiments, the network device transmits the downlink signaling to the terminal device. The downlink signaling indicates the at least one TA. Each of the at least one TA corresponds to one TRP. Correspondingly, the terminal device updates the at least one TA. In this way, the terminal device can adjust the TA values corresponding to different TRPs, such that each of the TRPs can receive uplink transmission from the terminal device at an appropriate time point.

In addition, in the method for indicating the TA according to these embodiments, the terminal device may use the same downlink reference point or different downlink reference points for the TAs of the plurality of TRPs based on the capability of the terminal device, thereby ensuring flexibility of the method for indicating the TA.

It should be noted that the foregoing method embodiments may be performed separately or in combination with each other, which is not limited in the present disclosure.

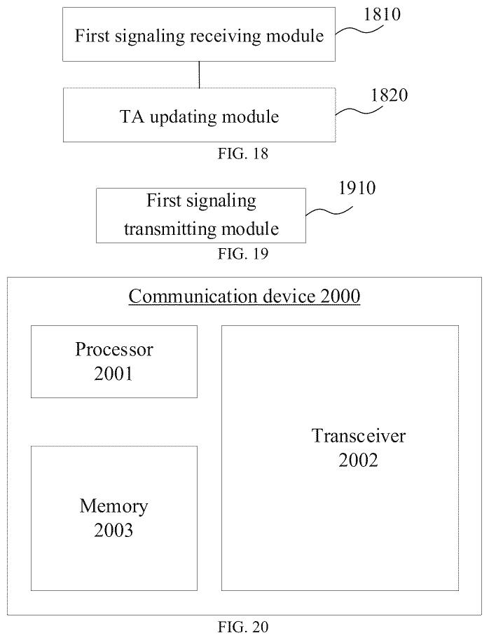

FIG. 18 is a structural block diagram of an apparatus for indicating a TA according to some embodiments of the present disclosure. The apparatus may be implemented as a terminal device or a part of the terminal device. A serving cell of the apparatus includes m TRPs, wherein m is a positive integer greater than or equal to 1. The apparatus includes a first signaling receiving module 1810 and a TA updating module 1820.

The first signaling receiving module 1810 is configured to receive downlink signaling, wherein the downlink signaling indicates at least one TA, each of the at least one TA corresponding to one of the m TRPs.

The TA updating module 1820 is configured to update the at least one TA based on the downlink signaling.

In some embodiments, the downlink signaling indicates m TAs corresponding to the m TRPs.

In some embodiments, the downlink signaling is a first MAC CE. The first MAC CE is applicable to mDCI-mTRP uplink transmission.

The first MAC CE includes m TA command fields. Each of the m TA command fields corresponds to one control resource set pool index. Each control resource set pool index corresponds to one TRP.

In some embodiments, a corresponding relationship between the TA command field and the control resource set pool index is predefined.

Alternatively, the first MAC CE further includes a control resource set pool index indicator field. The control resource set pool index indicator field indicates a corresponding relationship between the TA command field and the control resource set pool index.

In some embodiments, the downlink signaling is DCI. The DCI is applicable to sDCI-mTRP uplink transmission.

The DCI includes an SRS resource set field. The SRS resource set field corresponds to a first codepoint. The first codepoint indicates m TA values associated with m SRS resource sets. Each of the m SRS resource sets corresponds to one TRP.

In some embodiments, a first SRS resource set in the m SRS resource sets corresponds to at least one activated TA value. The TA value associated with the first SRS resource set is one of the at least one activated TA value.

The apparatus further includes a second signaling receiving module.

The second signaling receiving module is configured to receive a third MAC CE. The third MAC CE includes K TA value fields. The K TA value fields are defined to activate or deactivate the TA value corresponding to the first SRS resource set. K is a positive integer.

In some embodiments, the apparatus further includes a third signaling receiving module.

The third signaling receiving module is configured to receive RRC signaling. The RRC signaling includes a TA value configuration field, wherein the TA value configuration field is defined to configure a group of candidate TA values for the first SRS resource set.

The at least one activated TA value corresponding to the first SRS resource set is selected from the candidate TA values by a network device.

In some embodiments, the downlink signaling indicates one TA. The TA corresponds to one of the m TRPs.

In some embodiments, the downlink signaling is a second MAC CE. The second MAC CE is applicable to mDCI-mTRP uplink transmission.

The second MAC CE includes a TAG ID field. A TAG ID in the TAG ID field corresponds to one control resource set pool index. The control resource set pool index corresponds to one TRP.

In some embodiments, a corresponding relationship between the TAG ID and the control resource set pool index is predetermined.

Alternatively, a corresponding relationship between the TAG ID and the control resource set pool index is configured by a network device.

In some embodiments, the TA updating module is configured to update the at least one TA with a first TRP as a downlink reception reference point based on the downlink signaling.

Alternatively, the TA updating module is configured to update a TA corresponding to a second TRP with the second TRP as a downlink reception reference point based on the downlink signaling.

In some embodiments, the first TRP is predetermined.

Alternatively, the first TRP is configured by the network device.

In some embodiments, the downlink signaling is configured to instruct the apparatus to perform a difference-based TA update or an absolute value-based TA update.

In some embodiments, the apparatus further includes a capability information reporting module.

The capability information reporting module is configured to report capability information of the apparatus. The capability information includes at least one of: information indicating whether the apparatus supports TRP-specific TA adjustment, or a maximum quantity of TAs supported by the apparatus.

FIG. 19 is a structural block diagram of an apparatus for indicating a TA according to some embodiments of the present disclosure. The apparatus may be implemented as a network device or a part of the network device. The apparatus includes m TRPs, wherein m is a positive integer greater than or equal to 1. The apparatus includes a first signaling transmitting module 1910.

The first signaling transmitting module 1910 is configured to transmit downlink signaling, wherein the downlink signaling indicates at least one TA, each of the at least one TA corresponding to one of the m TRPs.

The downlink signaling is configured for a terminal device to update the at least one TA.

In some embodiments, the downlink signaling indicates m TAs corresponding to the m TRPs.

In some embodiments, the downlink signaling is a first MAC CE. The first MAC CE is applicable to mDCI-mTRP uplink transmission.

The first MAC CE includes m TA command fields. Each of the m TA command fields corresponds to one control resource set pool index. Each control resource set pool index corresponds to one TRP.

In some embodiments, a corresponding relationship between the TA command field and the control resource set pool index is predefined.

Alternatively, the first MAC CE further includes a control resource set pool index indicator field. The control resource set pool index indicator field indicates a corresponding relationship between the TA command field and the control resource set pool index.

In some embodiments, the downlink signaling is DCI. The DCI is applicable to sDCI-mTRP uplink transmission.

The DCI includes an SRS resource set field. The SRS resource set field corresponds to a first codepoint. The first codepoint indicates m TA values associated with m SRS resource sets. Each of the m SRS resource sets corresponds to one TRP.

In some embodiments, a first SRS resource set in the m SRS resource sets corresponds to at least one activated TA value. The TA value associated with the first SRS resource set is one of the at least one activated TA value.

The apparatus further includes a second signaling transmitting module.

The second signaling transmitting module is configured to transmit a third MAC CE. The third MAC CE includes K TA value fields. The K TA value fields are configured to activate or deactivate the TA value corresponding to the first SRS resource set. K is a positive integer.

In some embodiments, the apparatus further includes a third signaling transmitting module.

The third signaling transmitting module is configured to transmit RRC signaling. The RRC signaling includes a TA value configuration field, wherein the TA value configuration field is configured to configure a group of candidate TA values for the first SRS resource set.

The at least one activated TA value corresponding to the first SRS resource set is selected from the candidate TA values by the apparatus.

In some embodiments, the downlink signaling indicates one TA. The TA corresponds to one of the m TRPs.

In some embodiments, the downlink signaling is a second MAC CE. The second MAC CE is applicable to mDCI-mTRP uplink transmission.

The second MAC CE includes a TAG ID field. A TAG ID in the TAG ID field corresponds to one control resource set pool index. The control resource set pool index corresponds to one TRP.

In some embodiments, a corresponding relationship between the TAG ID and the control resource set pool index is predetermined.

In some embodiments, a corresponding relationship between the TAG ID and the control resource set pool index is configured by the apparatus.

In some embodiments, the downlink signaling is defined to instruct the terminal device to perform a difference-based TA update or an absolute value-based TA update.

In some embodiments, the apparatus further includes a capability information receiving module.

The capability information receiving module is configured to receive capability information reported by the terminal device. The capability information includes at least one of: information indicating whether the terminal device supports TRP-specific TA adjustment, or a maximum quantity of TAs supported by the terminal device.

It should be noted that in the case that the apparatus provided in the foregoing embodiments performs its functions, division of the functional modules is merely used as an example. In practice, the foregoing functions may be allocated to and completed by different functional modules as required, that is, an internal structure of the apparatus is divided into different functional modules to complete all or some of the foregoing functions.

Specific manners of performing operations by the modules in the apparatus in the foregoing embodiments have been described in detail in the embodiments of the related method, which are not described herein any further.

FIG. 20 is a schematic structural diagram of a communication device (terminal device or network device) according to some embodiments of the present disclosure. The communication device 2000 includes a processor 2001, a transceiver 2002, and a memory 2003.

The processor 2001 includes one or more processing cores. The processor 2001 runs a software program and module to execute various functional applications.

The transceiver 2002 may be configured to receive and transmit information. The transceiver 2002 may be a communication chip.

The memory 2003 may be configured to store at least one computer program. The processor 2001, when loading and running the at least one computer program, is caused to perform each process performed by the communication device in the foregoing method embodiments.

In addition, the memory 2003 may be implemented by any type of volatile or non-volatile storage device or a combination thereof. The volatile or non-volatile storage device includes but is not limited to a random-access memory (RAM), a read-only memory (ROM), an erasable programmable ROM (EPROM), an electrically EPROM (EEPROM), a flash memory or another solid-state storage technology, a compact disc ROM (CD-ROM), a high-density digital video disc (DVD) or another optical memory, a magnetic tape cartridge, a magnetic tape, a disk memory, or another magnetic memory device.

The processor 2001 and the transceiver 2002 involved in the embodiments of the present disclosure may perform the processes performed by the terminal device in any method illustrated in the foregoing embodiments, which are not described herein any further.

In some embodiments, the transceiver 2002 is configured to receive downlink signaling. The downlink signaling indicates at least one TA. Each of the at least one TA corresponds to one of m TRPs.

The processor 2001 is configured to update the at least one TA based on the downlink signaling.

The processor 2001 and the transceiver 2002 involved in the embodiments of the present disclosure may perform the processes performed by the network device in any method illustrated in the foregoing embodiments, which are not described herein any further.

In some embodiments, the transceiver 2002 is configured to transmit downlink signaling. The downlink signaling indicates at least one TA. Each of the at least one TA corresponds to one of m TRPs.

The downlink signaling is used by a terminal device to update the at least one TA.

In some embodiments, a non-transitory computer-readable storage medium is further provided. The non-transitory computer-readable storage medium stores at least one instruction, at least one program, a code set, or an instruction set. The at least one instruction, the at least one program, the code set, or the instruction set, when loaded and executed by a processor, causes the processor to perform the method for indicating the TA provided in the foregoing method embodiments.

In some embodiments, a chip is further provided. The chip includes a programmable logic circuit and/or a program instruction. When running on a terminal device or network device, the chip performs the method for indicating the TA according to the foregoing aspects.

In some embodiments, a computer program product is further provided. When running on a processor of a computer device, the computer program product is configured to perform the method for indicating the TA as described above.

Those of ordinary skill in the art can understand that all or some of the processes in the foregoing embodiments may be performed by hardware, or by instructing related hardware by using a program. The program may be stored in a non-transitory computer-readable storage medium. The storage medium may be a read-only memory, a disk, a compact disc, or the like.

It should be understood that the terms “system” and “network” herein are interchangeably used in the present disclosure. The term “and/or” herein merely indicates an association relationship describing associated objects, that is, three types of relationships. For example, the phrase “A and/or B” indicates (A), (B), or (A and B). In addition, the character “/” generally indicates an “or” relationship between the associated objects. It is understandable that the term “indicate” in the embodiments of the present disclosure means a direct indication, an indirect indication, or an associated relationship. For example, A indicating B, which mean that A indicates B directly, e.g., B is acquired by A; or that A indicates B indirectly, e.g., A indicates C, wherein B is acquired by C; or that an association relationship is present between A and B. It is understandable that the term “corresponding” may indicate a direct corresponding relationship or indirect corresponding relationship between two objects, or indicate an association relationship between two objects, or indicate relationships such as indicating and being indicated, configuring and being configured, or the like. It is understandable that the “predefined,” “protocol agreement,” “predetermined,” or “a predefined rule” is implemented by pre-storing a corresponding code, a table, or another manner that may indicate related information in the device (for example, the terminal device or the network device), and the specific implementations are not limited in the present disclosure. For example, the term “predefined” refers to defined in a protocol. It is understandable that the term “protocol” indicates a standard protocol in the field of communications. For example, the protocols include the LTE protocol, the NR protocol, and related protocols applied to the future communication system, which are not limited in the present disclosure.

The foregoing descriptions are merely embodiments of the present disclosure and are not intended to limit the present disclosure. Any modification, equivalent replacement, and improvement within the spirit and principle of the present disclosure shall be included within the protection scope of the present disclosure.

1. A method for indicating a timing advance (TA), wherein the method is applicable to a terminal device, a serving cell of the terminal device comprising m transmission and reception points (TRPs), m being a positive integer greater than or equal to 1, and the method comprises:
receiving downlink signaling, wherein the downlink signaling indicates at least one TA, each of the at least one TA corresponding to one of the m TRPs; and
updating the at least one TA based on the downlink signaling.

2. The method according to claim 1, wherein the downlink signaling indicates one TA, the TA corresponding to one of the m TRPs.

3. The method according to claim 2, wherein the downlink signaling is a second MAC CE;
wherein the second MAC CE is applicable to mDCI-mTRP uplink transmission; and the second MAC CE comprises a TA group (TAG) identifier (ID) field, a TAG ID in the TAG ID field corresponding to one control resource set pool index, the control resource set pool index corresponding to one TRP.

4. The method according to claim 3, wherein
a corresponding relationship between the TAG ID and the control resource set pool index is predetermined; or
a corresponding relationship between the TAG ID and the control resource set pool index is configured by a network device.

5. The method according to claim 1, wherein updating the at least one TA based on the downlink signaling comprises:
updating the at least one TA with a first TRP as a downlink reception reference point based on the downlink signaling; or
updating a TA corresponding to a second TRP with the second TRP as a downlink reception reference point based on the downlink signaling.

6. The method according to claim 5, wherein the first TRP is predetermined; or the first TRP is configured by the network device.

7. The method according to claim 1, further comprising:
reporting capability information of the terminal device, wherein the capability information comprises at least one of: information indicating whether the terminal device supports TRP-specific TA adjustment, or a maximum quantity of TAs supported by the terminal device.

8. A terminal device, wherein a serving cell of the terminal device comprises m transmission and reception points (TRPs), m being a positive integer greater than or equal to 1, and the terminal device comprises:
a transceiver, configured to receive downlink signaling, wherein the downlink signaling indicates at least one timing advance (TA), each of the at least one TA corresponds to one of the m TRPs; and
a processor, configured to update the at least one TA based on the downlink signaling.

9. The terminal device according to claim 8, wherein the downlink signaling indicates one TA, the TA corresponding to one of the m TRPs.

10. The terminal device according to claim 9, wherein the downlink signaling is a second MAC CE;
wherein the second MAC CE is applicable to mDCI-mTRP uplink transmission; and the second MAC CE comprises a TA group (TAG) identifier (ID) field, a TAG ID in the TAG ID field corresponding to one control resource set pool index, the control resource set pool index corresponding to one TRP.

11. The terminal device according to claim 10, wherein
a corresponding relationship between the TAG ID and the control resource set pool index is predetermined; or
a corresponding relationship between the TAG ID and the control resource set pool index is configured by a network device.

12. The terminal device according to claim 8, wherein the processor is configured to:
update the at least one TA with a first TRP as a downlink reception reference point based on the downlink signaling; or
update a TA corresponding to a second TRP with the second TRP as a downlink reception reference point based on the downlink signaling.

13. The terminal device according to claim 12, wherein the first TRP is predetermined; or the first TRP is configured by the network device.

14. The terminal device according to claim 8, wherein the downlink signaling is defined to instruct the terminal device to perform a difference-based TA update or an absolute value-based TA update.

15. A network device, wherein the network device comprises m transmission and reception points (TRPs), m being a positive integer greater than or equal to 1, and the network device comprises:
a transceiver, configured to transmit downlink signaling, wherein the downlink signaling indicates at least one timing advance (TA), each of the at least one TA corresponds to one of the m TRPs; and the downlink signaling is configured for a terminal device to update the at least one TA.

16. The network device according to claim 15, wherein the downlink signaling indicates one TA, the TA corresponding to one of the m TRPs.

17. The network device according to claim 16, wherein the downlink signaling is a second MAC CE;
wherein the second MAC CE is applicable to mDCI-mTRP uplink transmission; and the second MAC CE comprises a TA group (TAG) identifier (ID) field, a TAG ID in the TAG ID field corresponding to one control resource set pool index, the control resource set pool index corresponding to one TRP.

18. The network device according to claim 17, wherein
a corresponding relationship between the TAG ID and the control resource set pool index is predetermined; or
a corresponding relationship between the TAG ID and the control resource set pool index is configured by the network device.

19. The network device according to claim 15, wherein the downlink signaling is defined to instruct the terminal device to perform a difference-based TA update or an absolute value-based TA update.

20. The network device according to claim 15, wherein the transceiver is further configured to:
receive capability information reported by the terminal device, wherein the capability information comprises at least one of: information indicating whether the terminal device supports TRP-specific TA adjustment, or a maximum quantity of TAs supported by the terminal device.
